(19) United States
(12) Patent Application Publication
(10) Pub. No.: US 2024/0387908 A1
(43) Pub. Date: Nov. 21, 2024

(54) BUTTON LITHIUM-ION BATTERY, ELECTRONIC PRODUCT, AND PROCESS FOR PREPARING BUTTON LITHIUM-ION BATTERY

(71) Applicant: SHENZHEN GREPOW BATTERY Co.,Ltd, Shenzhen (CN)

(72) Inventors: AN HSUA HO, Shenzhen (CN); Yanqing Hu, Shenzhen (CN); Chunhua Luo, Shenzhen (CN); Qiangguang Li, Shenzhen (CN)

(21) Appl. No.: 18/664,419

(22) Filed: May 15, 2024

(30) Foreign Application Priority Data
May 15, 2023 (CN) 202310545200.4
May 15, 2023 (CN) 202321171934.2
Oct. 17, 2023 (CN) 202322798927.1

(51) Int. Cl. H01M 50/109; H01M 10/0525; H01M 10/0585; H01M 50/119; H01M 50/153; H01M 50/159; H01M 50/528; H01M 50/533; H01M 50/534; H01M 50/536; H01M 50/54; H01M 50/645

(52) U.S. Cl. CPC H01M 50/109; H01M 10/0525; H01M 10/0585; H01M 50/119; H01M 50/153; H01M 50/159; H01M 50/528; H01M 50/533; H01M 50/534; H01M 50/536; H01M 50/54; H01M 50/645

(57) ABSTRACT

The present disclosure relates to the field of lithium-ion batteries, and in particular to a button lithium-ion battery, an electronic product, and a process for preparing the button lithium-ion battery. A first insulation layer is spaced between an inner cover plate and an outer cover plate of the battery, a bottom face of the outer cover plate is connected with a second metal sheet, and tail ends of the first metal sheet and the second metal sheet exceed a periphery of the cover plate in respective; the first metal sheet, of a battery main body is stacked and fixedly connected with current collector exposed areas of various first pole pieces, and the second metal sheet exceeding the outside of the cover plate is stacked and fixedly connected with current collector exposed areas of various second pole pieces; and the battery main body is sealed in a metal housing.

### CROSS-REFERENCE RELATED REFERENCE

This application claims priorities of the Chinese Patent Application No. 202321171934.2, filed on May 15, 2023, the Chinese patent application with the application No. 202310545200.4, filed on May 15, 2023 and the Chinese patent application with the application No. 202322798927.1, filed on Oct. 17, 2023, the entire contents of which are incorporated herein by reference.

### TECHNICAL FIELD

The present disclosure relates to the field of battery manufacturing, and in particular to a button lithium-ion battery, an electronic product, and a process for preparing the button lithium-ion battery.

### BACKGROUND

As smart wearable products are more and more widely applied, users' demands for small-sized button secondary rechargeable batteries (button lithium-ion batteries for short) are also more and more wide. Currently, button lithium-ion batteries are the most widely used batteries. The more and more button lithium-ion batteries are applied in the smart wearable products, such as wireless Bluetooth earphones. With the wider and wider application of the button lithium-ion batteries, such as the application in earphones, the demands for the batteries also become increasingly higher.

### SUMMARY

One purpose of embodiments of the present disclosure is to provide a button lithium-ion battery, an electronic product, and a process for preparing the button lithium-ion battery, and adopting the technical solution is conductive to improving the assembly efficiency and internal space utilization rate of the button lithium-ion battery, thus improving the electric capacity density thereof.

In a first aspect, a button lithium-ion battery provided by this embodiment, including:
a metal housing with an opened end part;
a battery main body sealed in the metal housing and including a laminated body, where the laminated body includes a plurality of layers of stacked first pole pieces and second pole pieces as well as diaphragms spaced between any adjacent first pole pieces and the second pole pieces, one of each first pole piece and each second pole piece is an anode piece and the other is a cathode piece, first current collector exposed areas of the various first pole pieces stretch out of an outer edge of the laminated body and are stacked, and second current collector exposed areas of the various second pole pieces stretch out of another outer edge of the laminated body and are stacked; and
a cover plate including an inner cover plate and an outer cover plate that are made of metal, where an insulation layer is disposed between the inner cover plate and the outer cover plate, a bottom face of the inner cover plate is connected with a first metal sheet that is insulated and isolated from the outer cover plate, a bottom face of the outer cover plate is connected with a second metal sheet, tail ends of the first metal sheet and the second metal sheet stretch out of a periphery of the cover plate in respective, the first metal sheet stretches out of the end part of the periphery of the cover plate and is stacked and fixedly connected with the various first current collector exposed areas to insulate and coat a connecting part, the second metal sheet stretches out of the end part of the periphery of the cover plate and is stacked and fixedly connected with the current collector exposed areas of the various second pole pieces, and the cover plate is sealed at an opening of the metal housing.

In a second aspect, an electronic product provided by embodiments of the present disclosure has a power source from the above-mentioned button lithium-ion battery.

In a third aspect, a process for preparing a button lithium-ion battery provided by embodiments of the present disclosure, including:
closely attaching a first metal sheet stretching out of a periphery of a cover plate to top faces of various first current collector exposed areas that stretch out of a side of a laminated body of a battery main body and are stacked together, the various first current collector exposed areas separately serving as current collector foils that various first pole pieces stretch out of the side of the laminated body, a tail end of the first metal sheet being connected to a bottom face of the inner cover plate of the cover plate while the other tail end stretching out of the periphery of the cover plate, and the first metal sheet being insulated and isolated from the outer cover plate,
cutting short the length that the first metal sheet and the current collector exposed areas of the various first pole pieces stretch out of the side of the laminated body after the first metal sheet is stacked and fixedly connected with the first current collector exposed areas, and insulating and coating the first metal sheet and the various first current collector exposed areas that extend to the side of the laminated body and are stacked and fixed together;
closely attaching a second metal sheet stretching out of the periphery of the cover plate to top faces of various second current collector exposed areas that stretch out of the side of the laminated body and are stacked together, the various second current collector exposed areas separately serving as current collector foils that various second pole pieces stretch out of the side of the laminated body, a tail end of the second metal sheet being connected to a bottom face of the outer cover plate of the cover plate while the other tail end stretching out of the periphery of the cover plate,
cutting short the length that the second metal sheet and the current collector exposed areas of the various second pole pieces stretch out of the side of the laminated body after the second metal sheet is stacked and fixedly connected with the second current collector exposed areas,
the cover plate including the inner cover plate and the outer cover plate that are made of metal, and an insulation layer being spaced between the inner cover plate and the outer cover plate,
a battery main body including the laminated body, where the laminated body includes a plurality of layers of stacked first pole pieces and second pole pieces as well as diaphragms spaced between any adjacent first pole pieces and the second pole pieces, one of each first pole piece and each second pole piece is an anode piece and the other is a cathode piece; and
placing the battery main body into a metal housing, the cover plate sealing an opening of the metal housing, and sealing the battery main body in the metal housing.

Thus, it can be seen from the above that, on the one hand, applying the technical solution of welding the first metal sheet and the second metal sheet on the cover plate in advance, and stacking and fastening the two metal sheets with the two current collector exposed areas stacked together on the laminated body of the battery main body when welding the electrode of the button lithium-ion battery in this embodiment facilitates the electrode connection of the button lithium-ion battery, and on the other hand, the connecting length of the electrode may be cut short after the completion of the electrode welding in the technical solution, which can maximally reduce the occupation of the internal space of the metal housing by the electrode connecting part, and is conducive to improving the electric capacity density of the button lithium-ion battery.

### BRIEF DESCRIPTION OF THE DRAWINGS

The drawings illustrated herein are used for providing a further understanding of the present disclosure, and constitute a part of this application, but do not constitute improper limitations to the present disclosure.

FIG. 1 is a look-down schematic structural diagram of a cover plate suitable for a button lithium-ion battery provided by Embodiment 1 of the present disclosure.

FIG. 2 is a look-up schematic structural diagram of a cover plate shown in FIG. 1.

FIG. 3 is a solid schematic structural diagram of a cover plate shown in FIG. 1.

FIG. 4 is another look-down schematic structural diagram of a cover plate provided with a liquid injection hole on an inner cover plate and suitable for a button lithium-ion battery provided by Embodiment 1 of the present disclosure.

FIG. 5 is a look-up schematic structural diagram of a cover plate shown in FIG. 1.

FIG. 6 is a solid schematic structural diagram of a cover plate shown in FIG. 1.

FIG. 7 is an assembly schematic structural diagram before cutting a cover plate and a battery main body shown in FIG. 4.

FIG. 8 is an assembly schematic structural diagram after cutting a cover plate and a battery main body shown in FIG. 7.

FIG. 9 is a look-down schematic structural diagram of a cover plate suitable for a button lithium-ion battery provided by Embodiment 2 of the present disclosure.

FIG. 10 is a look-up schematic structural diagram of a cover plate shown in FIG. 9.

FIG. 11 is a solid schematic structural diagram of a cover plate shown in FIG. 9.

FIG. 12 is a schematic diagram of a decomposition main-view structure of an inner cover plate, an outer cover plate and a first insulation glue layer provided by Embodiment 2 of the present disclosure.

FIG. 13 is a look-down schematic structural diagram shown in FIG. 12.

FIG. 14 is a look-up schematic structural diagram shown in FIG. 12.

FIG. 15 is a solid schematic structural diagram shown in FIG. 12.

FIG. 16 is an assembly schematic structural diagram before cutting a cover plate and a battery main body shown in FIGS. 9 and 10.

FIG. 17 is a solid schematic structural diagram of another view of a structure shown in FIG. 8.

FIG. 18 is a solid schematic structural diagram that metal sheets and current collector exposed areas on both sides of a laminated body are cut and coated with high-temperature glue after being welded.

FIG. 19 is a solid schematic structural diagram of a button lithium-ion battery provided by Embodiment 2 of the present disclosure.

### REFERENCE SIGNS

21: Outer cover plate; 22: Inner cover plate; 23: First insulation glue layer;
3. Liquid injection hole; 41: First metal sheet; 42: Second metal sheet;
51: First current collector exposed area;
52: Second current collector exposed area;
1: Metal housing; 211: Cathode position identification portion;
221: Boss; 23: First insulation glue layer;
8: Sealing nail; 81: Welding trajectory; 5: Laminated body;
53: Diaphragm layer; 6: High-temperature adhesive tape.

### DETAILED DESCRIPTION OF THE EMBODIMENTS

The present disclosure is further described in detail below in combination with the drawings and specific embodiments. The exemplary embodiments of the present disclosure and the description thereof are used for explaining the present disclosure, but do not constitute limitations to the present disclosure.

### Embodiment 1

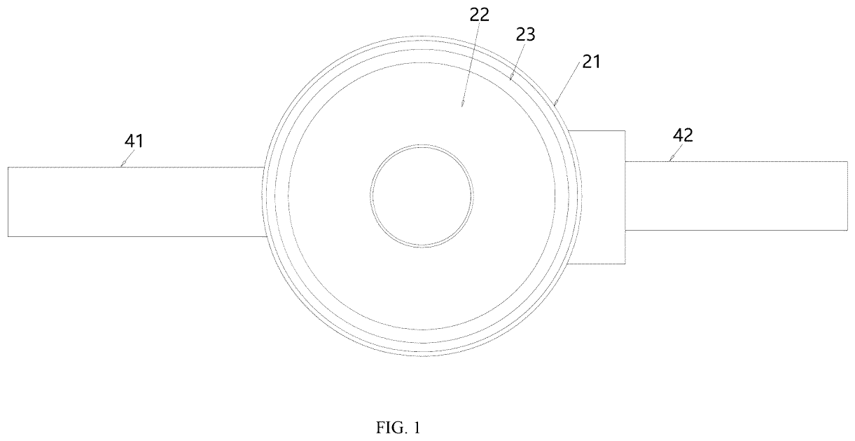

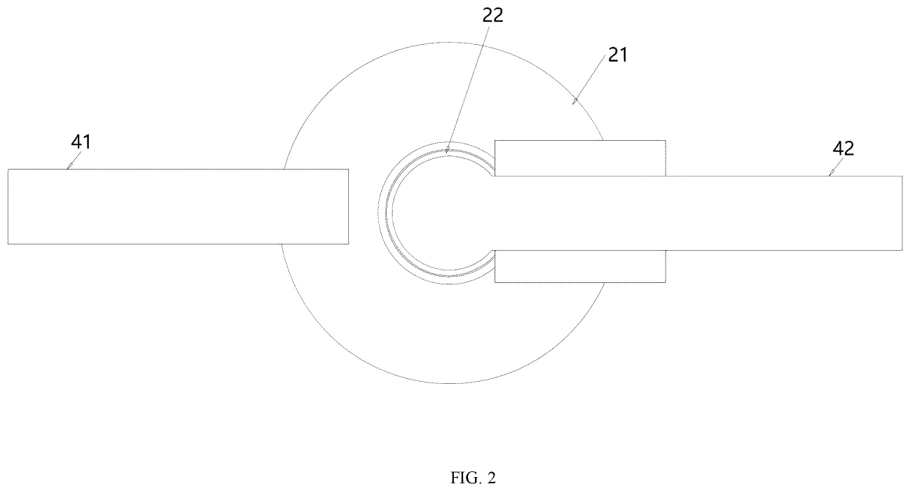

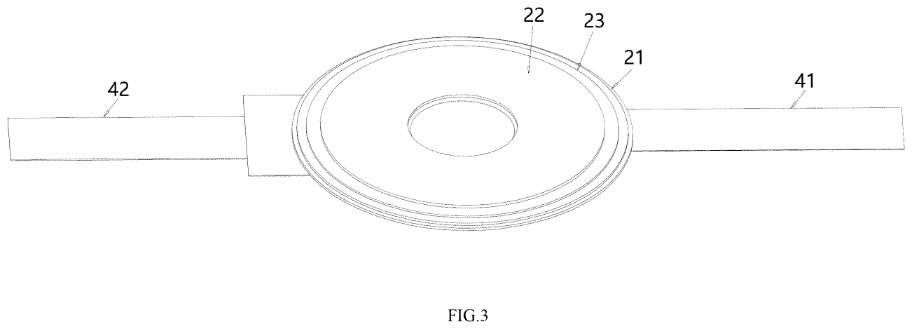

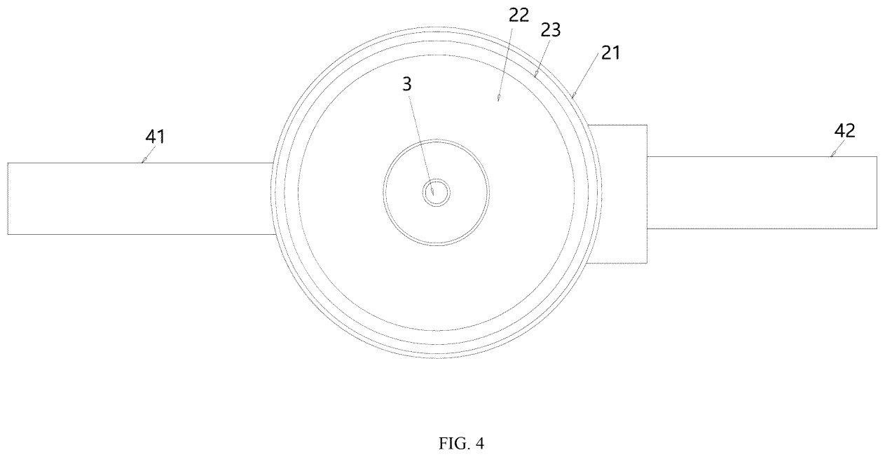

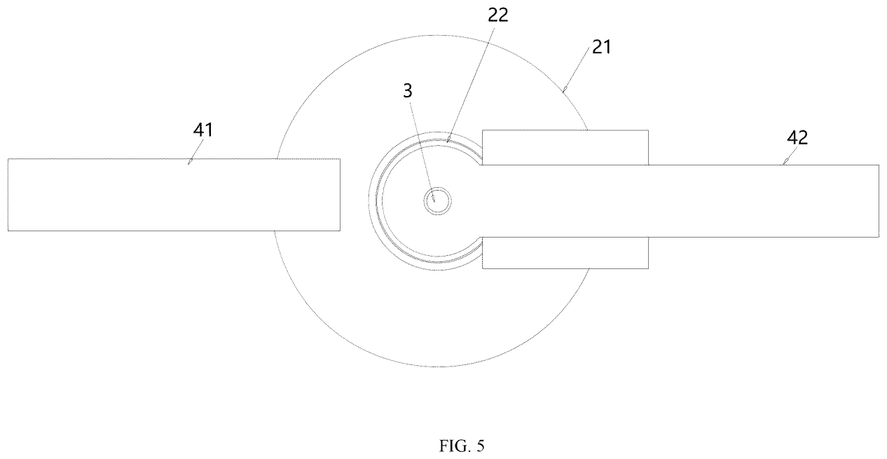

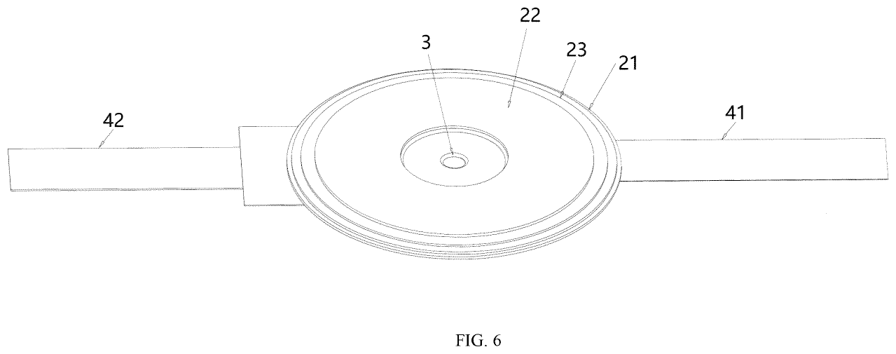

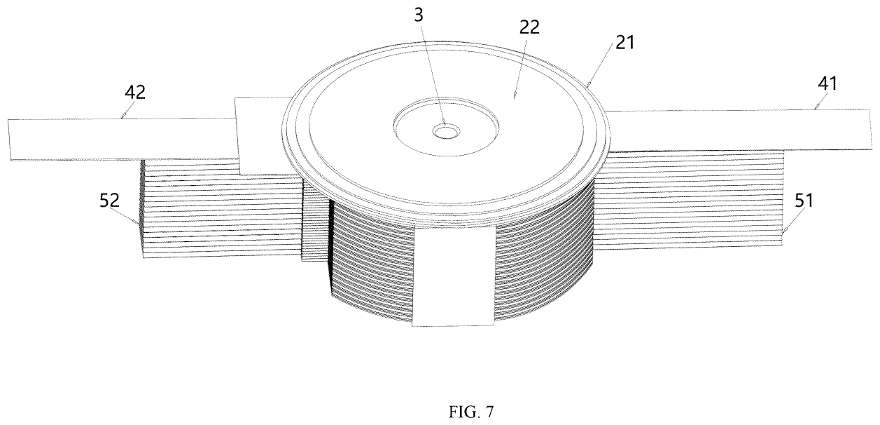

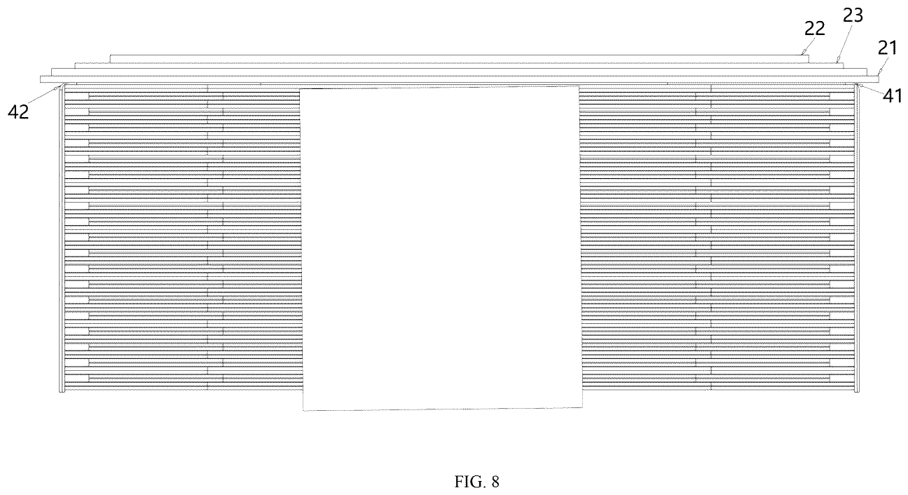

### Referring to FIG. 1 to FIG. 8.

A button lithium-ion battery provided by this embodiment, mainly including a battery main body, a metal housing with an opened top and a cover plate provided on the opening of the metal housing, where the battery main body is sealed in the metal housing by the cover plate.

The battery main body includes a laminated body, which is composed of a plurality of layers of stacked first pole pieces and second pole pieces as well as diaphragms spaced between any adjacent first pole pieces and the second pole pieces. One of each first pole piece and each second pole piece is an anode piece and the other is a cathode piece. The battery main body may be, but not limited to, a lithium-ion battery main body, and the preparation process for the laminated body of the lithium-ion battery main body refers to the prior art.

Metal current collector foils, extending to the side of the laminated body and not coated with polar materials, of the first pole pieces at various layers in the laminated body are denoted as first current collector exposed areas 51, and the first current collector exposed areas 51 stretching out of the various layers are stacked up and down and aligned with each other; and

metal current collector foils, extending to other positions of the side of the laminated body and not coated with the polar materials, of the second pole pieces at the various layers in the laminated body are denoted as second current collector exposed areas 52, and the second current collector exposed areas 52 stretching out of the various layers are stacked up and down and aligned with each other.

The cover plate includes an outer cover plate 21, an inner cover plate 22 and an insulation glue layer 23 spaced therebetween.

As an illustration of this embodiment, the cover plate may adopt the following structure, the outer cover plate 21 and the first insulation glue layer 23 are disposed to annular shapes with centers as through holes, the through hole at the center of the outer cover plate 21 is greater than that at the center of the first insulation glue layer 23, and during stacking, an inner edge of the first insulation glue layer 23 extends into the through hole at the center of the outer cover plate 21, and the inner cover plate 22 is disposed in the through hole at the center of the first insulation glue layer 23. The outer cover plate 21 and the inner cover plate 22 are located on both surfaces of the first insulation glue layer 23 in respective, and colloid on the both surfaces of the first insulation glue layer 23 are sealed and integrally combined with the outer cover plate 21 and the inner cover plate 22 attached to the first insulation glue layer 23. For example, but not limited to, the colloid on the both surfaces of the first insulation glue layer 23 is thermally molten through hot-pressing, so as to be in full contact with the surfaces of the outer cover plate 21 and the inner cover plate 22 that are attached to the first insulation glue layer 23, then the colloid is sealed and integrally combined with the surfaces of the outer cover plate 21 and the inner cover plate 22 after cooling. Also, but not limited to, when preparing the first insulation glue layer 23 through injection molding, the outer cover plate 21 and the inner cover plate 22 are placed in a preset mold, the hot-melting colloid is in full contact with the surfaces of the outer cover plate 21 and the inner cover plate 22 in the mold, and after the hot-melting colloid cools and sets, the first insulation glue layer 23 sealed and combined between the outer cover plate 21 and the inner cover plate 22 is obtained, that is, the integrated cover plate is obtained.

In this embodiment, the first metal sheet 41 and the second metal sheet 42 that are independent of each other are connected with the bottom face of the cover plate in respective, an opposite face of a tail end face of the first metal sheet 41 is closely attached and connected with the bottom face of the inner cover plate, the other end stretches out of the periphery of the outer cover plate 21, and an insulation layer is disposed between the first metal sheet 41 and the bottom face of the outer cover plate 21, to insulate and space the first metal sheet 41 and the outer cover plate 21, thus avoiding a short circuit.

An opposite face of a tail end face of the second metal sheet 42 is closely attached and connected with the bottom face of the outer cover plate 21, the other end stretches out of the periphery of the cover plate. As an illustration of this embodiment, it may allow, but not limited to, the first metal sheet 41 and the second metal sheet 42 to stretch out of both sides of the outer cover plate 21 separately and relatively, such that the two metal sheets are not on the same side completely and staggered, facilitating the welding connection of the metal sheet and avoiding the contact of the short circuit.

When preparing the cover plate, the length that the first metal sheet 41 and the second metal sheet 42 stretch out the periphery of the outer cover plate 21 may be reserved to be relatively long, for ease of stacking and welding with the current collector exposed areas of the laminated body.

As an illustration of this embodiment, the cover plate is placed at the top face of the laminated body of the battery main body, such that the first metal sheet 41 is in face-to-face attaching to top faces of the first current collector exposed areas 51 closely attached together, the first metal sheet 41 and the various first current collector exposed areas 51 form laminated structures that are fixedly connected together, and the laminated structures may be, but not limited to, connected by welding.

Similarly, the second metal sheet 42 is in face-to-face attaching to top faces of the second current collector exposed areas 52 closely attached together, the first metal sheet 41 and the various first current collector exposed areas 51 form laminated structures that are fixedly connected together, and the laminated structures may be, but be not limited to, connected by welding.

As an illustration of this embodiment, in this embodiment, the first metal sheet 41 and the second metal sheet 42 that are disposed on the cover plate may be designed to stretch out of the both sides of the cover plate relatively; and correspondingly, the various first current collector exposed areas 51 and the various second current collector exposed areas 52 on the laminated body extend to the both sides of the laminated body relatively. Adopting this technology is easier to position the electrode, and convenient to weld and assemble the button lithium-ion battery.

The first metal sheet 41 and the first current collector exposed areas 51 at the various layers that are stacked and fixedly connected together are cut, and on the basis of their connecting tightness, the length stretching out of the laminated body is cut short, to reserve a very short section. The insulation material is coated outside the remaining first metal sheet 41 and the first current collector exposed areas 51 at the various layers that are closely fastened. As an illustration of this embodiment, the first metal sheet 41 and the first current collector exposed areas 51 (coated with the insulation layer) at the various layers that are closely fastened may also be, but not limited to, bent downward on the side of the laminated body, and the second metal sheet 42 and the second current collector exposed areas 52 (coated with the insulation layer) at the various layers that are closely fastened is bent downward on the side of the laminated body.

The battery main body is placed into a cavity of the metal housing from the opening of the metal housing, the cover plate seals the opening of the metal housing, and the battery main body is sealed in the metal housing.

In this embodiment, the periphery of the outer cover plate 21 is the periphery of the cover plate, and the periphery of the outer cover plate 21 is sealed, combined and connected with the opening of the metal housing, to implement the sealing connection of the cover plate and the metal housing. As an illustration of this embodiment, laser welding may, but not limited to, allow the the bottom face, closely attached to the end face of the opening of the metal housing, of the outer edge of the outer cover plate 21 to be sealed and combined with the metal at the end face of the opening of the metal housing through melting under a high-temperature effect, thus implementing the sealing connection of the cover plate and the metal housing. Thus, the inner cover plate 22 on the cover plate serves as a first electrode of the button lithium-ion battery, and the outer cover plate 21 and the metal housing serve as second electrodes of the button lithium-ion battery, to provide the power source externally.

As an illustration of this embodiment, in this embodiment, when the electrolyte in the battery main body is an electrolyte solution, the electrolyte solution may be soaked to the inside of the laminated body before being placed in the metal housing, or enter from the opening of the metal housing for electrolyte solution injection before sealing the cover plate.

Relative to the technical solution that a polar stacked current collector exposed area is welded on the cover body while another polar current collector exposed area is welded on the metal housing in the prior art, the operation flow in the prior art is more complex, and a relatively long current collector exposed area needs to be designed when the prior art is adopted, such that the polar stacked and fixed current collector exposed areas are bent from one side of the metal housing to the cover plate for welding, and another polar stacked and fixed current collector exposed areas are bent from the other side of the metal housing to the bottom of the metal housing for welding, and a relatively great internal space of the metal housing needs to be occupied, which is not conductive to improving the electric capacity density of the button lithium-ion battery.

On the one hand, applying the technical solution of welding the first metal sheet 41 and the second metal sheet 42 on the cover plate in advance, and stacking and fastening the two metal sheets with the two current collector exposed areas stacked together on the laminated body of the battery main body when welding the electrode of the button lithium-ion battery in this embodiment facilitates the electrode connection of the button lithium-ion battery, and on the other hand, the connecting length of the electrode may be cut short after the completion of the electrode welding in the technical solution, which can maximally reduce the occupation of the internal space of the metal housing by the electrode connecting part, and is conducive to improving the electric capacity density of the button lithium-ion battery.

As an illustration of this embodiment, the liquid injection hole 3 may also be provided on the bottom cover of the metal housing or the inner cover plate 22 or the outer cover plate 21, after the cover plate is sealed, the electrolyte solution injection is performed through the liquid injection hole 3, and adopting the technical solution for pouring after sealing is conductive to infecting the electrolyte solution on the metal housing or the cover plate, thus affecting the welding reliability of the metal housing and the tightness.

After the completion of the electrolyte solution pouring, the liquid injection hole 3 is sealed through a sealing nail. To improve the sealing effect of the sealing nail, the laser welding is performed from the top face of the sealing nail, an annular welding trajectory is formed at the top face of the sealing nail, and the liquid injection hole 3 is enclosed in a ring formed by the welding trajectory and spaces a certain distance from the welding trajectory. At the position of the welding trajectory, the bottom face of the sealing nail is molten, sealed and combined integrally with the metal on the metal surface attached to the sealing nail, and adopting this structure is conductive to reducing the influence of the residual electrolyte solution on the laser welding, to ensure the sealing effect of the welding.

### Embodiment 2

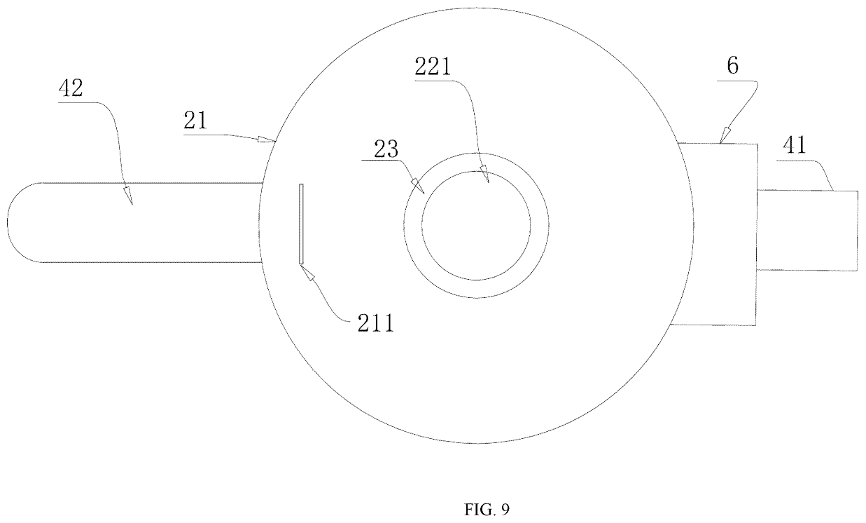

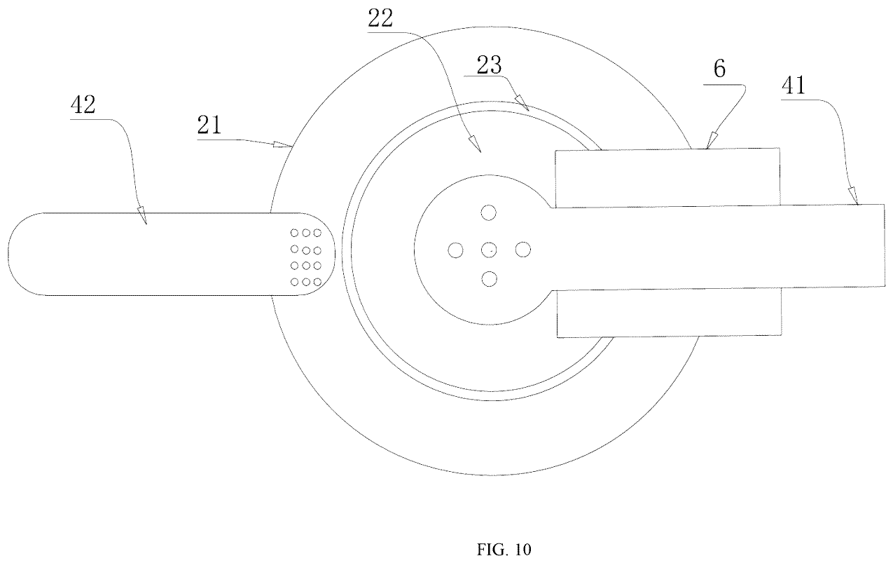

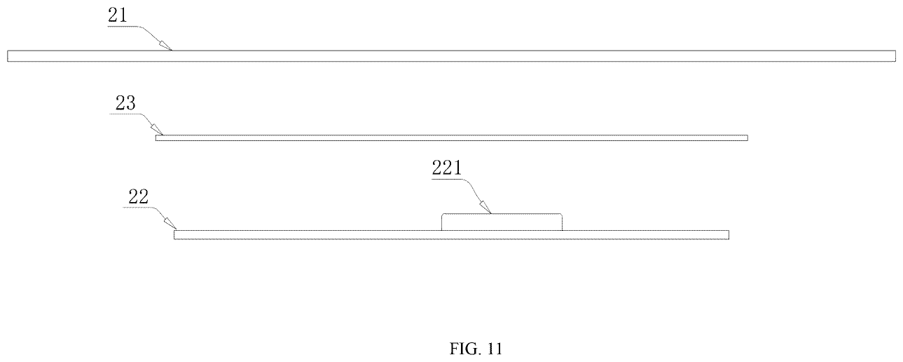

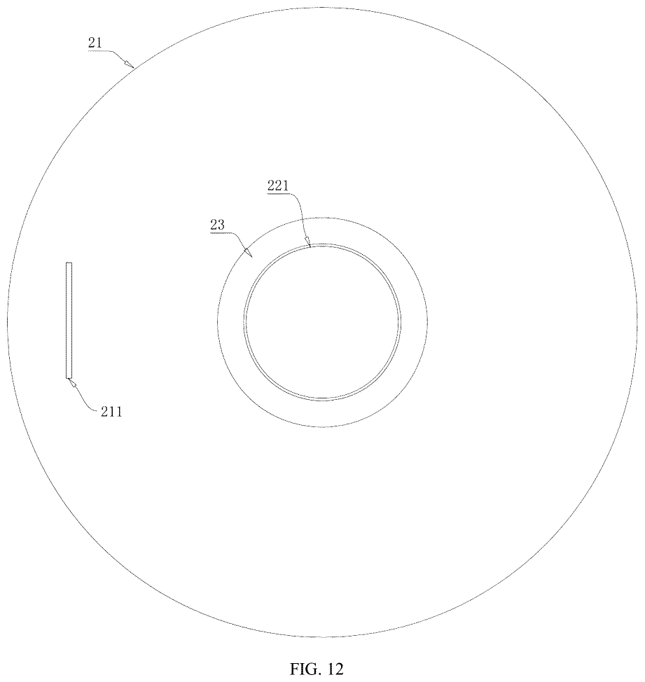

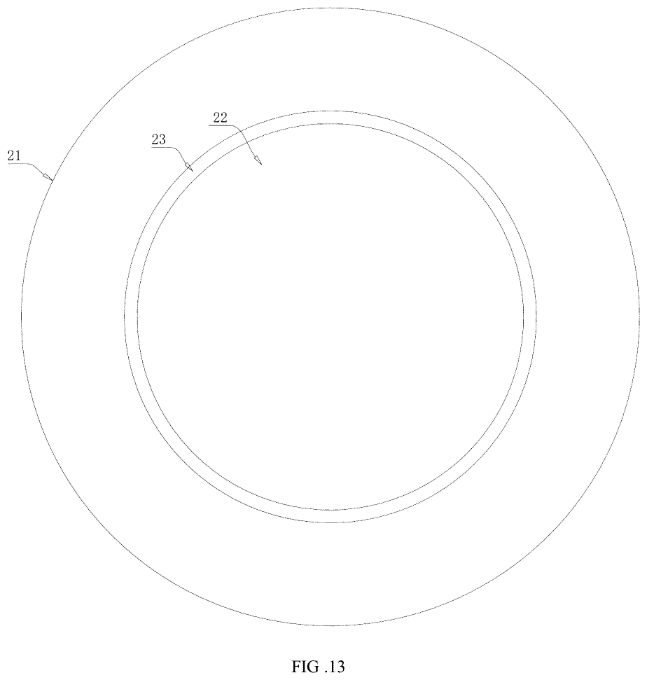

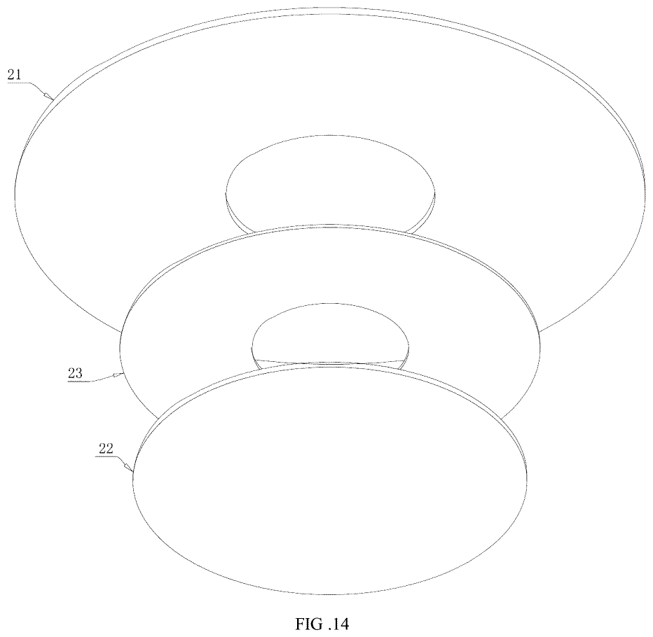

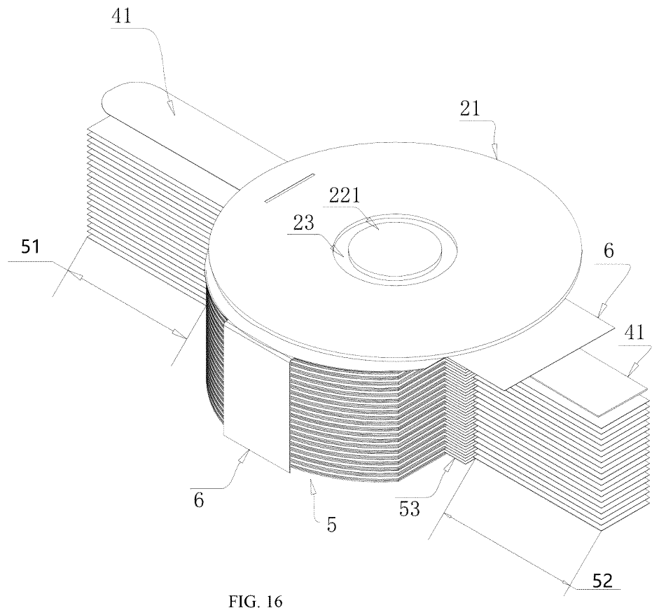

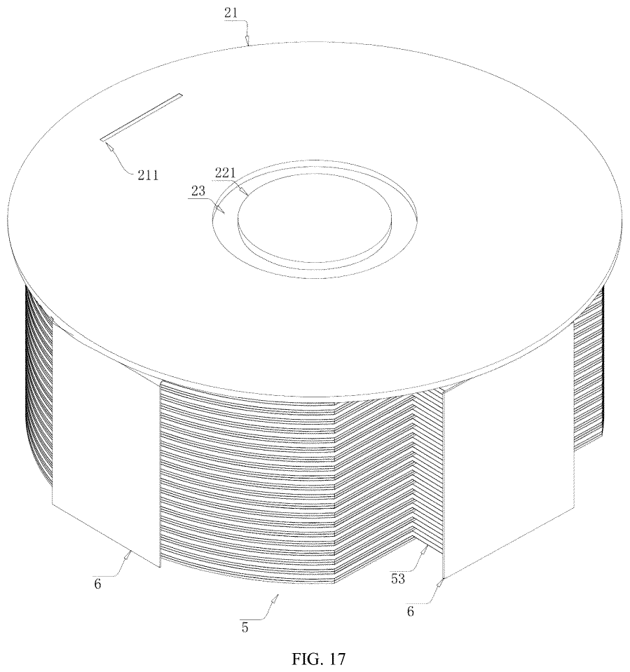

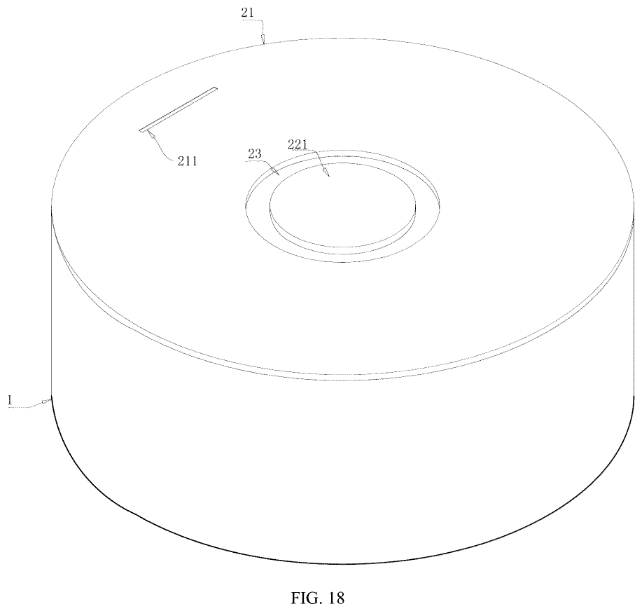

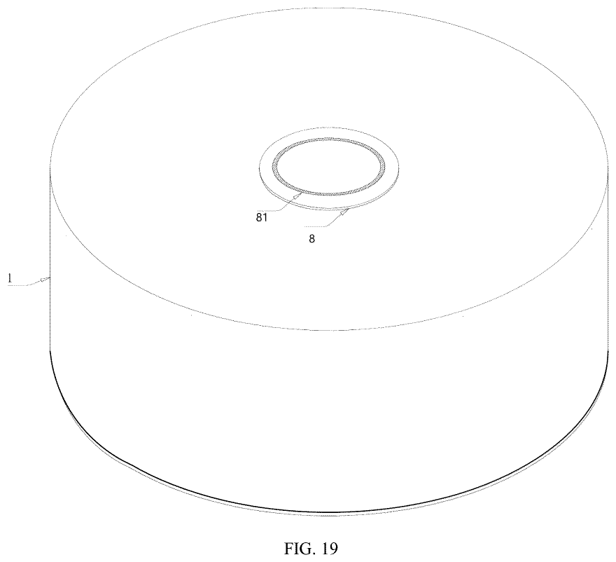

### Referring to FIGS. 9-19.

A button lithium-ion battery provided by this embodiment, mainly including a battery main body, a metal housing 1 with an opened top and a cover plate provided on the opening of the metal housing 1, where the battery main body is sealed in the metal housing 1 by the cover plate.

The battery main body includes a Laminated body 5, which is composed of a plurality of layers of stacked first pole pieces and second pole pieces as well as a plurality of diaphragm layers 53 spaced between any adjacent first pole pieces and the second pole pieces; and the first pole pieces and the second pole pieces that are located on both sides of the diaphragms are insulated and isolated from each other by the various diaphragm layers 53, and after stacking, the Laminated body 5 is tied by the high-temperature adhesive tape 6 to be finalized.

One of each first pole piece and each second pole piece is an anode piece and the other is a cathode piece, and in this embodiment, the first pole piece being the anode and the second pole piece being the cathode are taken as an illustration.

The battery main body may be, but not limited to, a lithium-ion battery main body, and the preparation process for the Laminated body 5 refers to the prior art.

Current collector foils, extending to the side of the Laminated body 5 and not coated with polar materials, of the first pole piece sat various layers in the Laminated body 5 are denoted as first current collector exposed areas 51, and the first current collector exposed areas 51 stretching out of the various layers are stacked up and down and aligned with each other.

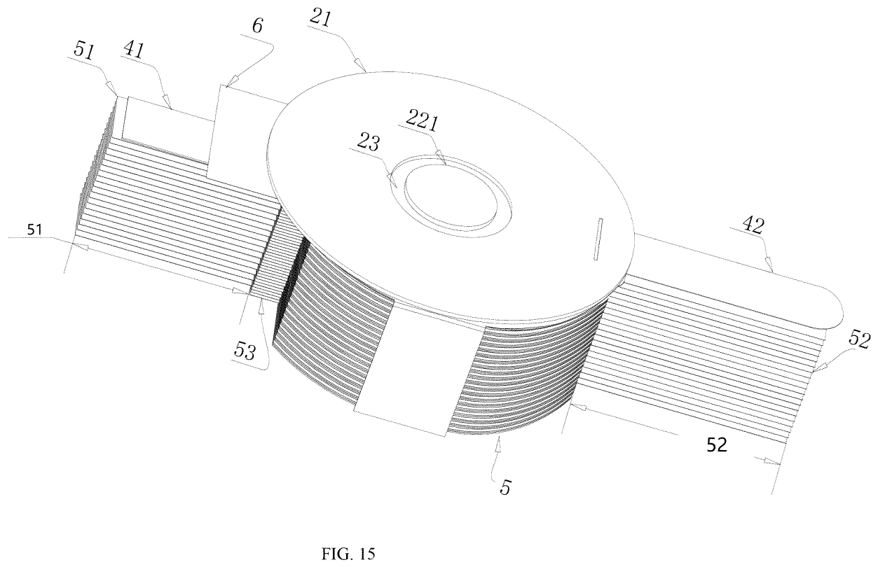

Current collector foils, extending to other positions of the side of the Laminated body 5 and not coated with the polar materials, of the second pole pieces at the various layers in the Laminated body 5 are denoted as second current collector exposed areas 52, and the second current collector exposed areas 52 stretching out of the various layers are stacked up and down and aligned with each other. Referring to FIGS. 15, 16 and 17, the various diaphragm layers 53 stretch out to some extent in a same direction at stretching-out positions of the second current collector exposed areas 52 at the various layers, and the stretching-out length of the various diaphragm layers 53 is shorter than that of the second current collector exposed areas 52 at the various layers.

The cover plate includes an outer cover plate 21, an inner cover plate 22 and an insulation glue layer 23 spaced therebetween, such as, but be not limited to, the high-temperature adhesive tape 6.

As an illustration of this embodiment, the cover plate may adopt the following structure, the outer cover plate 21 and the first insulation glue layer 23 are disposed to an annular shape with centers as through holes, and the through hole at the center of the outer cover plate 21 is greater than that at the center of the first insulation glue layer 23. The inner cover plate 22 is a panel, and a raised boss 221 is disposed at the top face of the inner cover plate 22.

During stacking, the first insulation glue layer 23 is closely attached between the bottom face of the outer cover plate 21 and the top face of the inner cover plate 22 as an intermediate layer, the hole diameter of the through hole at the center of the first insulation glue layer 23 is less than that of the through hole at the center of the outer cover plate 21, when the two through holes face each other, the inner edge of the first insulation glue layer 23 extends into the through hole at the center of the outer cover plate 21, the outer diameter of the inner cover plate 22 is greater than the hole diameter of the through hole of the outer cover plate 21, the boss 221 at the top face of the inner cover plate 22 stretches out of the through holes of the outer cover plate 21 and the first insulation glue layer 23 to be exposed at the top face of the outer cover plate 21, and the top face outside the boss 221 of the inner cover plate 22 is closely attached to the bottom face of the first insulation glue layer 23. Thus, the outer cover plate 21 and the inner cover plate 22 are located on both surfaces of the first insulation glue layer 23 in respective, and colloid on the both surfaces of the first insulation glue layer 23 is sealed and integrally combined with the outer cover plate 21 and the inner cover plate 22 that are attached to the first insulation glue layer 23.

For example, but be not limited to, the colloid on the both surfaces of the first insulation glue layer 23 is thermally molten through hot-pressing, so as to be in full contact with the surfaces of the outer cover plate 21 and the inner cover plate 22 that are pasted to the first insulation glue layer 23, then the colloid is sealed and integrally combined with the surfaces of the outer cover plate 21 and the inner cover plate 22 after cooling. Also, but be not limited to, when preparing the first insulation glue layer 23 through injection molding, the outer cover plate 21 and the inner cover plate 22 are placed in a preset mold, the hot-melting colloid is in full contact with the surfaces of the outer cover plate 21 and the inner cover plate 22 in the mold, and after the hot-melting colloid cools and sets, the first insulation glue layer 23 sealed and combined between the outer cover plate 21 and the inner cover plate 22 is obtained, that is, the integrated cover plate is obtained.

At the bottom face of the cover plate, an opposite face of a tail end face of the first metal sheet 41 is closely attached and welded to the bottom face of the inner cover plate 22, the other end is a free end and extends to the periphery of the outer cover plate 21 along the bottom face of the cover plate, and an insulation isolation sheet is disposed between the first metal sheet 41 and the bottom face of the outer cover plate 21, to insulate and space the first metal sheet 41 and the outer cover plate 21, thus avoiding a short circuit. An opposite face of a tail end face of the second metal sheet 42 is closely attached and welded to the bottom face of the outer cover plate 21, and the other end is a free end and extends to the periphery of the cover plate along the bottom face of the cover plate.

Thus, it can be seen that, on the cover plate in this embodiment, the inner cover plate 22 is disposed inside the cover plate, the cover plate 22 is wider than the outer cover plate 21 and the hole diameter of the through hole of the center of a first high-temperature adhesive tape 623, and during use of the button lithium-ion battery, air pressure inside the battery acts on the inner cover plate 22, allowing a sealing connection between the inner cover plate 22 and the outer cover plate 21 to be more stable, thus the cover plate has stronger tightness.

The top face of the outer cover plate 21 is also provided with a cathode position identification portion 211, which on the one hand indicates a cathode connecting position located inside the cover plate, and on the other hand identifies positions of the first insulation glue layer 23 at the bottom face of the cover plate and the inner cover plate 22 (located inside the cathode position identification portion 211).

As an illustration of this embodiment, it may allow, but be not limited to, the first metal sheet 41 and the second metal sheet 42 to stretch out of both opposite sides of the outer cover plate 21 separately and relatively, such that the two metal sheets are completely staggered, facilitating the welding of the metal sheet at the bottom face of the cover plate, and also facilitating connecting the free ends of the two metal sheets with the exposed areas of the various pole pieces on both sides of the Laminated body 5.

When preparing the cover plate, a relatively long length of the first metal sheet 41 and the second metal sheet 42 is reserved, to ensure that the length stretching out of the periphery of the outer cover plate 21 is long enough and sufficiently bent outside the Laminated body 5, for ease of closely attaching to the exposed areas of the current collectors of the pole pieces stretching out of the outer side of the Laminated body 5 for welding, and thus implementing the connection of the electrodes of the button Lithium-ion battery and the Laminated body 5.

As an illustration of this embodiment, the cover plate is placed at the top face of the laminated body of the battery main body, such that the first metal sheet 41 is located above the various first current collector exposed areas 51 stretching out of the outer side of the Laminated body 5, and the second metal sheet 42 is located above the various second current collector exposed areas 55 stretching out of another outer side of the Laminated body 5.

The Laminated body 5 and the cover plate are placed on a welding clamp of an ultrasonic welding machine, and the various first current collector exposed areas 51 stretching out of the outer side of the laminated body are located on a welding table (the welding table may be a welding head with an ultrasonic welding function or a common platform; and the welding table may be, but not limited to, a fixed portion or a component not limited to a lifting movement or a horizontal movement).

The welding head is located above the first metal sheet and declines, under the action of the welding head, the first metal sheet stretching out of the outer side of the cover plate is bent downward from the side of the top of the Laminated body 5 to the edge, the various first current collector exposed areas 51 stretching out of the outer side of the Laminated body 5 is bent downward until the the first metal sheet and the various first current collector exposed areas 51 are compressed between the welding head and the welding table, the first sheet and the various first current collector exposed areas 51 that are closely attached together are welded through ultrasonic waves, and return to the welding head after the completion of the welding, that is, the first sheet and the various first current collector exposed areas 51 are compressed and welded to the outer side of the Laminated body 5.

Similarly, the second sheet and the various second current collector exposed areas 52 are compressed and welded at another outer side of the Laminated body 5 through the ultrasonic welding.

As an illustration of this embodiment, in this embodiment, the ultrasonic welding is taken as an illustration, but actually, laser welding or other welding processes may be, but not limited to, adopted.

At this point, the welding for the electrodes of the cover plate and the Laminated body 5 is completed.

At a predetermined position outside the welding area, the first sheet 41 and the various first current collector exposed areas 51 as well as the second sheet 42 and the various second current collector exposed areas 52 are cut short, respectively.

After cutting, high-temperature adhesive tapes 6 are separately coated outside the remaining first sheet 41 and the various first current collector exposed areas 51 that are closely attached and welded together as well as outside the remaining second sheet 42 and the various second current collector exposed areas 52 that are closely attached and welded together. Adopting the coating technology with the high-temperature adhesive tapes 6 is conductive to protecting the tail end of the metal, thus avoiding the tail end of the metal to puncture the housing and the Laminated body 5.

When coating the high-temperature adhesive tapes 6, the structure, located on the both sides of the Laminated body 5 and coated with the high-temperature adhesive tapes 6, is bent further to reduce the occupied space thereof. Then, the battery main body is placed into the cavity of the metal housing 1 from the opening of the metal housing 1, the cover plate located at the top face of the Laminated body 5 is in sealing connection with the opening of the metal housing 1, and the battery main body is sealed in the metal housing 1 through the cover plate.

As an illustration of this embodiment, in this embodiment, the first metal sheet 41 and the second metal sheet 42 that are disposed on the cover plate may be designed to stretch out of the both sides of the cover plate relatively; and correspondingly, the various first current collector exposed areas 51 and the various second current collector exposed areas 52 on the Laminated body 5 extend to the both sides of the Laminated body 5 relatively. Adopting the relative setting process is more convenient to weld and assemble the button lithium-ion battery.

In this embodiment, the periphery of the outer cover plate 21 is the periphery of the cover plate, and the periphery of the outer cover plate 21 is sealed, combined and connected with the opening of the metal housing 1, to implement the sealing connection of the cover plate and the metal housing 1. As an illustration of this embodiment, laser welding may, but be not limited to, allow the the end face, closely attached to the opening of the metal housing 1, of the outer edge of the outer cover plate 21 to be sealed and combined with the metal material at the end face of the opening of the metal housing 1 through metal melting, thus implementing the sealing connection of the outer cover plate 21 and the metal housing 1. The inner cover plate 22 on the cover plate serves as the first electrode of the button lithium-ion battery, and the outer cover plate 21 and the metal housing 1 serve as the second electrodes of the button lithium-ion battery, to provide the power source externally.

As an illustration of this embodiment, in this embodiment, when the electrolyte in the battery main body is an electrolyte solution, the electrolyte solution may be soaked to the inside of the Laminated body 5 before being placed in the metal housing 1, or enter from the opening of the metal housing 1 for the electrolyte solution pouring before sealing the cover plate.

In the prior art, a relatively long lug needs to be connected, such that one lug can be bent to the top of the Laminated body 5 from one side of the Laminated body 5, then welded to the cover plate at the top of the Laminated body 5. Another lug is bent to the top of the Laminated body 5 from the side of the Laminated body 5 and welded to the bottom of the metal housing 1, and adopting the prior art enables the operation process to be complex and takes more space.

On the one hand, applying the technical solution of welding the first metal sheet 41 and the second metal sheet 42 on the cover plate in advance, and stacking and fastening the two metal sheets with the current collector exposed areas stacked together on the Laminated body 5 of the battery main body when welding the electrode of the button lithium-ion battery in this embodiment facilitates the electrode connection of the button lithium-ion battery, and on the other hand, the length of the metal sheets and the current collector exposed areas may be cut short after the completion of the electrode welding by adopting this technical solution, which can maximally reduce the occupation of the internal space of the metal housing 1 by the electrode connecting part, and is conducive to improving the electric capacity density of the button lithium-ion battery.

As an illustration of this embodiment, the liquid injection hole may also be provided on the bottom of the metal housing 1, after the cover plate is sealed, the electrolyte solution pouring is performed through the liquid injection hole, and adopting the technical solution for pouring after sealing is conductive to infecting the electrolyte solution on the metal housing 1 or the cover plate, thus affecting the welding reliability of the metal housing 1 and the tightness. After the completion of the electrolyte solution pouring, the liquid injection hole is sealed through a Sealing nail 8. To improve the sealing effect of the Sealing nail 8, the laser welding is performed from the top face of the Sealing nail 8, an annular welding trajectory 81 is formed at the top face of the Sealing nail 8, and the liquid injection hole is enclosed in a ring formed by the Welding trajectory 81 and spaces a certain distance from the Welding trajectory 81. At the position of the Welding trajectory 81, the bottom face of the Sealing nail 8 is molten, sealed and combined integrally with the metal at the bottom, and adopting this structure is conductive to reducing the influence of the residual electrolyte solution on the laser welding, to ensure the sealing effect of the welding. And the technical solution for providing the liquid injection hole on the bottom instead of the cover plate in this embodiment is conductive to improving the working efficiency.

The above implementations do not constitute a limitation to the protection scope of the technical solution. Any modifications, equivalent replacements, improvements and the like made within the spirit and principle of the above implementations shall be included in the protection scope of the technical solution.

1. A button lithium-ion battery, comprising:
a metal housing with an opened end part;
a battery main body sealed in the metal housing and comprising a laminated body, wherein the laminated body comprises a plurality of layers of stacked first pole pieces and second pole pieces as well as diaphragms spaced between any adjacent first pole pieces and the second pole pieces, one of each first pole piece and each second pole piece is an anode piece and the other is a cathode piece, first current collector exposed areas of the various first pole pieces stretch out of an outer edge of the laminated body and are stacked, and second current collector exposed areas of the various second pole pieces stretch out of another outer edge of the laminated body and are stacked; and
a cover plate comprising an inner cover plate and an outer cover plate that are made of metal, wherein an insulation layer is disposed between the inner cover plate and the outer cover plate, a bottom face of the inner cover plate is connected with a first metal sheet that is insulated and isolated from the outer cover plate, a bottom face of the outer cover plate is connected with a second metal sheet, tail ends of the first metal sheet and the second metal sheet stretch out of a periphery of the cover plate in respective, the first metal sheet stretches out of the end part of the periphery of the cover plate and is stacked and fixedly connected with the various first current collector exposed areas to insulate and coat a connecting part, the second metal sheet stretches out of the end part of the periphery of the cover plate and is stacked and fixedly connected with the current collector exposed areas of the various second pole pieces, and the cover plate is sealed at an opening of the metal housing.

2. The button lithium-ion battery according to claim 1, wherein
the outer cover plate is an annular plate with a center as a through hole, a top face of the outer cover plate is the top face of the cover plate, a periphery of the outer cover plate is the periphery of the cover plate, and the outer cover plate is sealed at the opening of the metal housing, as an electrode of the button lithium-ion battery,
the inner cover plate is a panel whose diameter is greater than that of the through hole of the outer cover plate, the inner cover plate is sealed and combined with a bottom face of the outer cover plate through the insulation layer, to seal the through holes of the outer cover plate and the insulation layer, a boss of the top face of the inner cover plate stretches out of the through holes of the outer cover plate and the insulation layer to be exposed on the top face of the cover plate, as another electrode of the button lithium-ion battery;
one end of the first metal sheet is connected to a bottom face of the inner cover plate while the other end is bent from the top of the laminated body to one side thereof; and on this side: exposed areas of current collectors of the various first pole pieces are closely attached and welded together due to bending, and the first metal sheet is closely attached and welded to the outermost side that is closely attached to the exposed areas of the current collectors of the various first pole pieces; and
one end of the second metal sheet is connected to the bottom face of the outer cover plate while the other end is bent from the top of the laminated body to the other side thereof; and on this side: exposed areas of current collectors of the various second pole pieces are closely attached and welded together due to bending, and the second metal sheet is closely attached and welded to the outermost side that is closely attached to the exposed areas of the current collectors of the various second pole pieces.

3. The button lithium-ion battery according to claim 1, wherein
the first metal sheet and the second metal sheet stretch out of two opposite sides of the cover plate, respectively; and
the current collector exposed areas of the various first pole pieces and the current collector exposed areas of the various second pole pieces stretch out of both sides of the battery main body relatively.

4. The button lithium-ion battery according to claim 3, wherein
a bottom face of an outer edge of the outer cover plate is sealed and integrally combined with an end face at the opening of the metal housing through metal melting.

5. The button lithium-ion battery according to claim 1, wherein
each first pole piece is an anode piece, while each second pole piece is a cathode piece.

6. The button lithium-ion battery according to claim 1, wherein
an liquid injection hole for pouring an electrolyte is also provided on the metal housing or the inner cover plate or the outer cover plate, and a sealing nail is covered at the liquid injection hole, to seal the liquid injection hole.

7. An electronic product, which has a power source from the button lithium-ion battery according to claim 1.

8. The electronic product according to claim 7, wherein
the outer cover plate is an annular plate with a center as a through hole, a top face of the outer cover plate is the top face of the cover plate, a periphery of the outer cover plate is the periphery of the cover plate, and the outer cover plate is sealed at the opening of the metal housing, as an electrode of the button lithium-ion battery,
the inner cover plate is a panel whose diameter is greater than that of the through hole of the outer cover plate, the inner cover plate is sealed and combined with a bottom face of the outer cover plate through the insulation layer, to seal the through holes of the outer cover plate and the insulation layer, a boss of the top face of the inner cover plate stretches out of the through holes of the outer cover plate and the insulation layer to be exposed on the top face of the cover plate, as another electrode of the button lithium-ion battery,
one end of the first metal sheet is connected to a bottom face of the inner cover plate while the other end is bent from the top of the laminated body to one side thereof; and on this side: exposed areas of current collectors of the various first pole pieces are closely attached and welded together due to bending, and the first metal sheet is closely attached and welded to the outermost side that is closely attached to the exposed areas of the current collectors of the various first pole pieces; and
one end of the second metal sheet is connected to the bottom face of the outer cover plate while the other end is bent from the top of the laminated body to the other side thereof; and on this side: exposed areas of current collectors of the various second pole pieces are closely attached and welded together due to bending, and the second metal sheet is closely attached and welded to the outermost side that is closely attached to the exposed areas of the current collectors of the various second pole pieces.

9. The electronic product according to claim 7, wherein
the first metal sheet and the second metal sheet stretch out of two opposite sides of the cover plate, respectively; and
the current collector exposed areas of the various first pole pieces and the current collector exposed areas of the various second pole pieces stretch out of both sides of the battery main body relatively.

10. The electronic product according to claim 9, wherein
a bottom face of an outer edge of the outer cover plate is sealed and integrally combined with an end face at the opening of the metal housing through metal melting.

11. The electronic product according to claim 7, wherein
each first pole piece is an anode piece, while each second pole piece is a cathode piece.

12. The electronic product according to claim 7, wherein
an liquid injection hole for pouring an electrolyte is also provided on the metal housing or the inner cover plate or the outer cover plate, and a sealing nail is covered at the liquid injection hole, to seal the liquid injection hole.

13. A process for preparing a button lithium-ion battery; comprising:
closely attaching a first metal sheet stretching out of a periphery of a cover plate to top faces of various first current collector exposed areas that stretch out of a side of a laminated body of a battery main body and are stacked together, the various first current collector exposed areas separately serving as current collector foils that various first pole pieces stretch out of a side of the laminated body, a tail end of the first metal sheet being connected to a bottom face of the inner cover plate of the cover plate while the other tail end stretching out of the periphery of the cover plate, and the first metal sheet being insulated and isolated from the outer cover plate,
cutting short the length that the first metal sheet and the current collector exposed areas of the various first pole pieces stretch out of the side of the laminated body after the first metal sheet is stacked and fixedly connected with the first current collector exposed areas, and insulating and coating the first metal sheet and the various first current collector exposed areas that extend to the side of the laminated body and are stacked and fixed together;
closely attaching a second metal sheet stretching out of the periphery of the cover plate to top faces of various second current collector exposed areas that stretch out of the side of the laminated body and are stacked together, the various second current collector exposed areas separately serving as current collector foils that various second pole pieces stretch out of the side of the laminated body, a tail end of the second metal sheet being connected to a bottom face of the outer cover plate of the cover plate while the other tail end stretching out of the periphery of the cover plate,
cutting short the length that the second metal sheet and the current collector exposed areas of the various second pole pieces stretch out of the side of the laminated body after the second metal sheet is stacked and fixedly connected with the second current collector exposed areas,
the cover plate comprising the inner cover plate and the outer cover plate that are made of metal, and an insulation layer being spaced between the inner cover plate and the outer cover plate,
a battery main body comprising the laminated body, wherein the laminated body comprises a plurality of layers of stacked first pole pieces and second pole pieces as well as diaphragms spaced between any adjacent first pole pieces and the second pole pieces, one of each first pole piece and each second pole piece is an anode piece and the other is a cathode piece; and
placing the battery main body into a metal housing, the cover plate sealing an opening of the metal housing, and sealing the battery main body in the metal housing.

14. The process for preparing the button lithium-ion battery according to claim 13, wherein
after sealing the battery main body in the metal housing, further comprising:
pouring an electrolyte inside the metal housing through a liquid injection hole provided on the metal housing or the inner cover plate or the outer cover plate, and
a sealing nail sealing the liquid injection hole, to seal the liquid injection hole.

15. The process for preparing the button lithium-ion battery according to claim 13, wherein
after insulating and coating the first metal sheet and the various first current collector exposed areas that stretch out of the side of the laminated body and are stacked and fixed together, further comprising:
downward bending the first metal sheet and the various first current collector exposed areas outside the side of the laminated body along a root thereof connected to the laminated body, and
downward bending the second metal sheet and the various second current collector exposed areas outside the side of the laminated body along a root thereof connected to the laminated body.
